(19) United States
(12) Patent Application Publication
(10) Pub. No.: US 2011/0058141 A1
(43) Pub. Date: Mar. 10, 2011

(54) SPECTACLES WITH LIGHT SOURCES FOR ILLUMINATING AN OBJECT OBSERVED THROUGH THE LENS AND RELATED EARPIECES

(76) Inventor: Laura Maria Cozzani, Alzate Brianza (IT)

(21) Appl. No.: 12/866,310

(22) PCT Filed: Feb. 5, 2008
(86) PCT No.: PCT/IT08/00069

§ 371 Date: Nov. 23, 2010

(51) Int. Cl. G02C 11/04

(52) U.S. Cl. 351/158

(57) ABSTRACT

Earpieces (1) for spectacles integrating a light source (6, 16) at its front end have at their free distal end a pre-constituted detachable module (4) containing at least a powering battery (B), a switch (11) and electrical connecting means to said light source (6, 16) and having a certain cross section and an end surface, through an opening (14) of which a control stem (13) of the switch projects. A pair of electrical supply wires (17, 18) of the light source run inside a slender front and proximal part of the earpiece, the cross section of which gradually increases as far as matching the enlarged cross section of the detachable distal end module (4). The front and proximal part of the earpiece may have a box-like structure composed of two channel cross section elements (2, 3) joined together for defining at least a conduit along which run the electrical supply wires (17, 18). Alternatively, the earpiece (1) is made in monolithic form defining in a distal part of enlarged cross section (Ia) a cavity adapted to receive a pre-constituted plug-in module (4) containing said battery (B), switch (11) and electrical connecting means (17b, 18b, partly enveloped by an end shell (Ib), through an opening (14) of which the control stem (13) of the switch projects.

The present invention relates in general to spectacles with light sources for illuminating an object observed through the lens and in particular to earpieces of a spectacles frame incorporating a lighting device.

Endowing common spectacles of battery powered devices for illuminating an object observed through the lens is a practice that has been proposed and developed for a long time and that benefits from the availability of efficient LED type (acronym for Light Emitting Diode) light sources, which beside a high conversion efficiency of electrical energy to a light energy have far smaller sizes compared to the size of a classic miniature lamp. This is documented by the wealth of publications that describe different approaches and solutions to the problem of making spectacles frame with built in light sources.

CN 20061032873 discloses spectacles with LED incorporated in the front frame and in the earpieces.

CN 2906672YY discloses spectacles with LEDs incorporated in the front frame with earpieces, a part of which hinged to the front mask is hollow and accommodates a LED and related electrical hardware including a slider switch. The other part of the earpiece that plugs into the first part contains a powering battery.

GB-2411009 discloses spectacles with lighting LEDs installed at the front end of the earpieces as well as on the central bridge piece of the front frame of the spectacle. The earpieces contain a battery and a switch for turning on/off the LEDs and a jack or inductor coil for recharging the battery.

US-2003-086053 discloses lighting LED modules that may be mounted onto the earpieces of the spectacles.

WO 2007/008062 A1 discloses spectacles with light sources. A button type powering battery is introduced inside a slot cavity defined within the thickness of the earpiece that also includes a slider switch for turning on and off the battery powered LED. The LED are installed at the front end of the earpieces or in the front mask of the spectacles, in the latter case by realizing isolated sliding contacts within the connecting hinge.

These proposal and approaches have so far not been favored by the market because of a persistently poor ergonomicity and because the inevitable additional weight of the powering battery, being them rechargeable or primary batteries, of the LED and of the relative switches and other components of the electrical circuit makes tiresome to wear the spectacles for a long period of time because the increased weight bears for a substantial part of it on the nose of the bearer.

The miniaturized slider switches that is normally incorporated in the earpiece is difficult to locate and operate by relying on tactile sense while wearing the spectacles. The enlarging of the earpieces as far as necessary to accommodate the powering battery, the switch and the electrical hardware and connecting wing to the front LED, makes the general aspect of the worn eyeglasses not so pleasant. Fabrication of the earpieces and the realization at their interior of the electrical powering circuit of one or more LEDs is according to the known approaches rather laborious and costly.

It is a first object of the present invention to provide spectacles integrating light sources for illuminating an object observed through the lens with enhanced ergonomic characteristics and practicalness of use.

It is a further objective of this invention to provide spectacle earpieces integrating a light source and related powering circuit though preserving for the front and proximal part of their extension the aspect of common earpieces even of particularly slender cross section.

According to a first aspect of the present invention, a single light source is incorporated or mounted at the front end of the earpiece while the powering battery of the light source and a switch are accommodated in a terminal distal portion of the earpiece, substantially beyond the point of rest of the earpiece on the ear of the wearer of the spectacles, of enlarged cross section compared to the cross section of the front and proximal part of the earpiece. The extra weight of the powering module is born mainly by the ears, practically relieving from it the more sensible nose of the bearer.

According to another aspect of the present invention, turning on and off the light source is effected through a switch, the control stem of which projects from the end surface of the earpiece, to be immediately felt by the finger of the bearer and easily operated.

A further aspect of the present invention consists in that the connecting wires of the frontally installed light source to the electrical powering circuit components housed at the farther or distal end of the earpiece, run inside part of the earpiece having a box-like hollow structure composed by two channel cross section elements or semi-earpiece joined together.

The invention is defined in the annexed claims.

FIG. 1 is a photographic rendering of an earpiece for spectacles integrating a light source of the present invention.

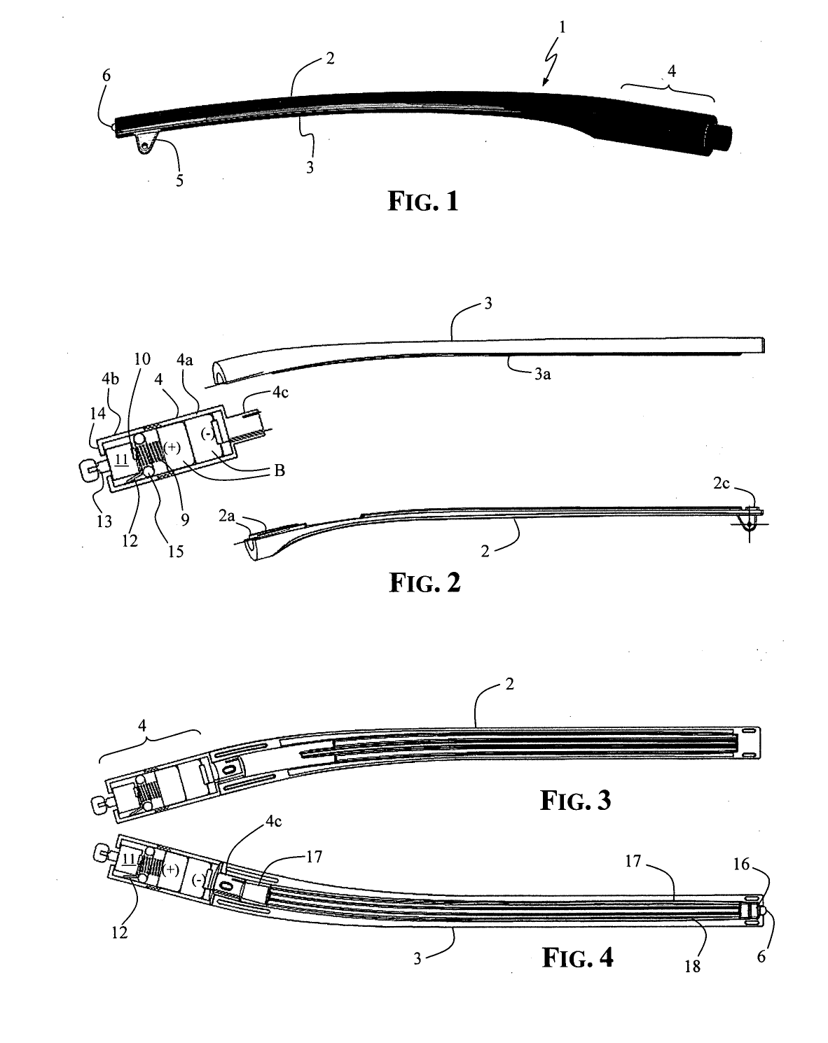

FIG. 2 is an exploded view of an earpiece according to first exemplary embodiment.

FIGS. 3 and 4 are views showing respectively the two channel cross section semi-earpieces that compose the front and proximal part of the earpiece of FIG. 2, coupled to a distal cartridge-shaped part of the earpiece containing the electrical powering devices.

FIG. 5 shows enlarged details of the earpiece of the preceding figures.

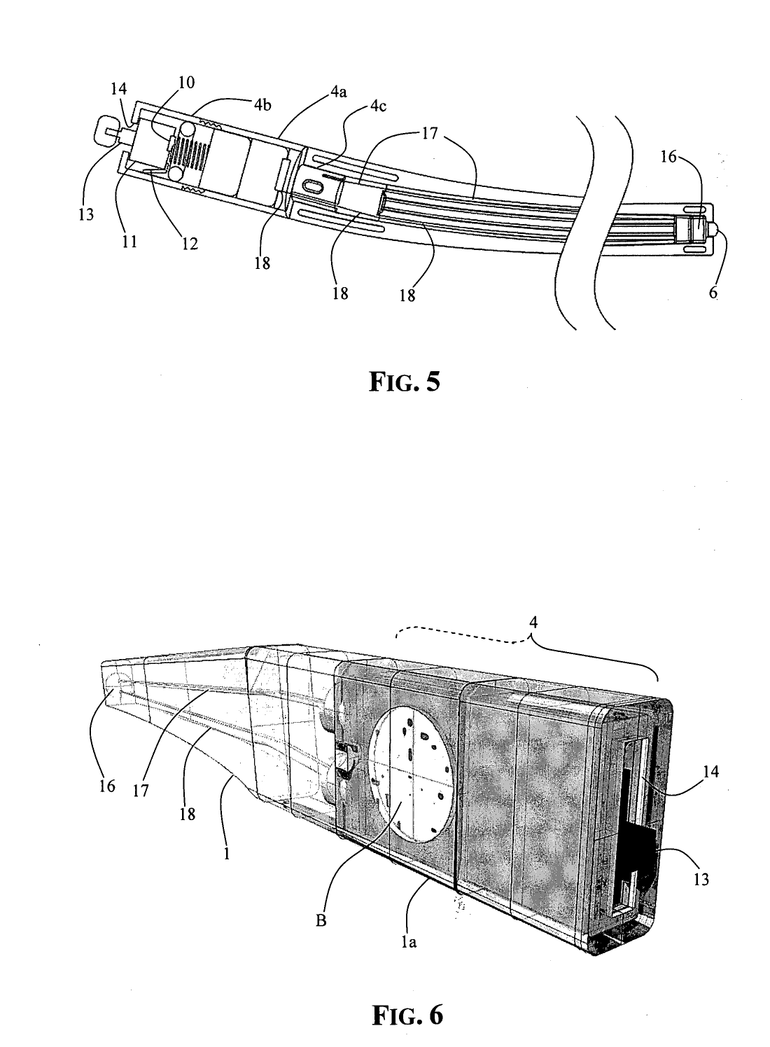

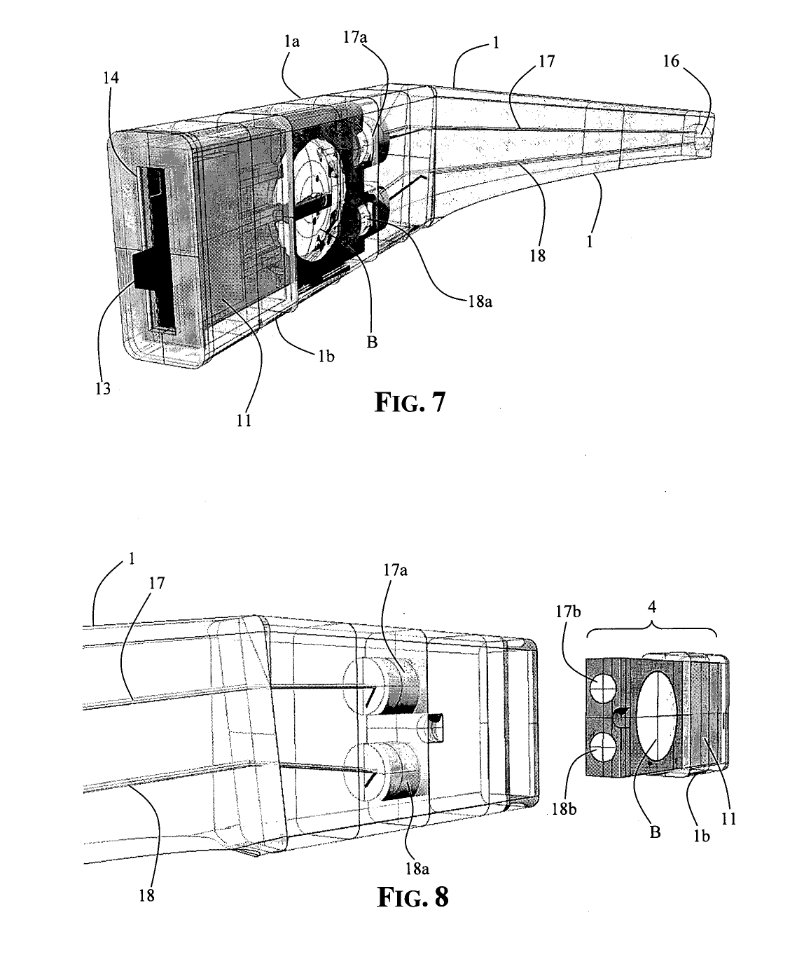

FIG. 6 is a schematic view of an earpiece made according to an alternative exemplary embodiment.

FIG. 7 shows the other side of the earpiece of the FIG. 6.

FIG. 8 is an exploded view showing the way electrical contacts between a separable powering module and a two-wire connecting line to the front light source are established.

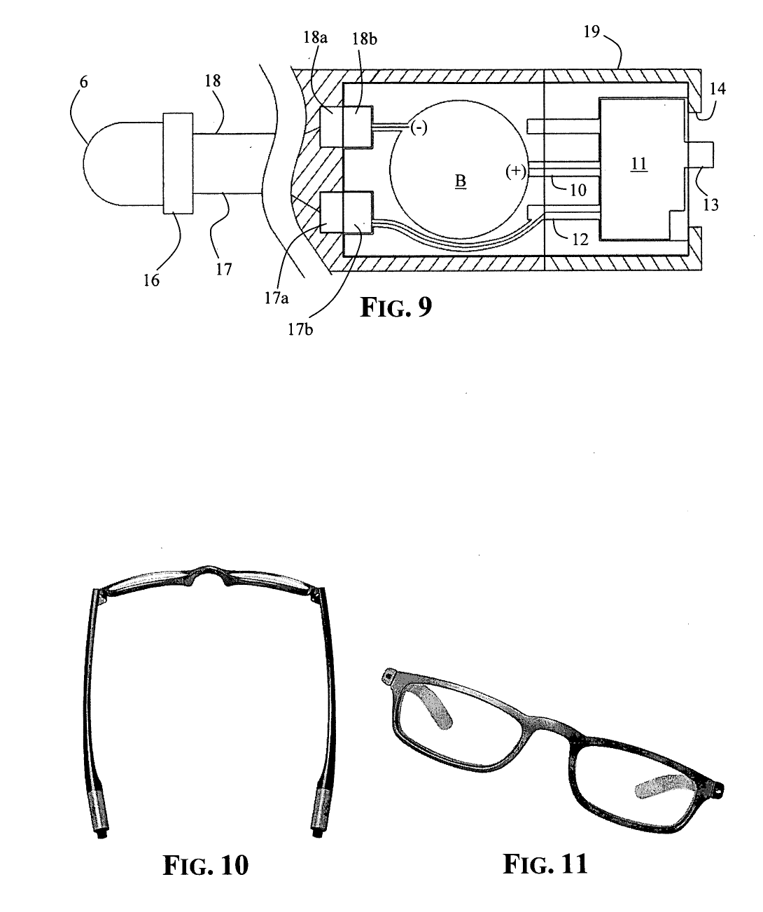

FIG. 9 is an electrical diagram of the circuit incorporated in the earpiece of FIGS. 6-8.

FIGS. 10 and 11 are photographic renderings of a pair of spectacles with earpieces of FIGS. 1-5.

Figure from 1 to 5 illustrate a first exemplary embodiment of an earpiece for spectacles integrating a light source according to the present invention.

According to this first embodiment, the front and a proximal part of the earpiece 1 has a box-like structure resulting by joining channel cross section relatively slender semi-earpieces 2 and 3 and a distal part 4 of enlarged cross section compared to the front and proximal part of the earpiece.

From the external surface of the semi-earpiece 3 extends, in the example shown, a holed wing 5 which will eventually be engaged in a common fastening hinge of the earpiece to a front frame of the spectacles (not depicted in the Figure).

A light source is accommodated and retained in a front end recess defined by coupling together two channel-cross section semi-earpieces 2 and 3. Of the light source, typically a LED, in FIG. 1 is observable only the terminal lens 6.

In the exploded view of FIG. 2, the two channel cross section semi-earpieces 2 and 3 may be better observed and so is the geometry of the coupling perimeters provided with moldings 2a and 2b and 2c that are destined to engage themselves in specularly formed channels or recesses formed along the coupling perimeter of the other semi-earpiece 3, which has a median longitudinal stiffening rib 3a the crest molding of which engages in a corresponding longitudinal recess formed along the crest of a corresponding longitudinal median rib formed in the first semi-earpiece 2, such that upon coupling together the two pieces, the inner space of the so-defined box-like structure is longitudinally divided, for a good portion of the length of the earpiece, in two distinct channels. Moreover, the median longitudinal ribs present along both channel cross section semi-earpieces 2 and 3 confer to the resulting hollow body an enhanced rigidity.

As may be observed, the distal end portion of the two semi-earpieces 2 and 3 is to shaped such to confer to the distal end of this part of the earpiece of box-like structure a cross section that gradually increases as far as matching without any substantial discontinuity the enlarged cylindrical cross section of the distal part of the earpiece 4 which, in the illustrated example, comprises a cylindrical cartridge of aluminum or other light weight electrically conducting metallic material composed by telescopically screwing together two parts: respectfully a coupling end part 4a and an end or closing part 4b.

The coupling end part 4a has a central tail 4c transversed by a hole 7 for receiving a blocking pin passed across the tailed portion 4c, after having introduced it inside an end receptacle defined by the two semi-earpieces 2 and 3 joined together and at least the wall of one or of both the two semi-earpieces, according to common assembling practices.

The cartridge 4 contains at least one, in the depicted example two, button type batteries B in series held by a metal spring 9 that establishes also the electrical connection between the positive terminal (+) of the series of two batteries B to a first lead 10 of a push-button switch 11, a second lead 12 of which is bent in order to establishing electrical contact with the metal cartridge 4 itself. The control stem 13 of the switch emerges through an opening of the end face 14 of the distal cartridge part 4 of the earpiece 1.

A common O-ring 15 stops and sustains in position the switch 11.

FIGS. 3 and 4 show the end cartridge 4 respectfully associated to one and to the other of the two semi-earpieces 2 and 3 that compose the box-like front and proximal part of the earpiece.

In FIG. 4 that shows the terminal cartridge 4 and the semi-earpiece 3 may be observed the front end LED 16, held between the tongued ends of the two semi-earpieces, and the pair of connecting wires respectively running in the two channels defined in the interior of the box-like structure of the earpiece. The wire 17 connects the respective lead of the LED 16 to the metallic bulk of the cylindrical cartridge 4 that is short circuited through the switch 11 to the positive pole of the series of two button batteries B by the bent lead 12. The other wire 18, optionally provided with an isolating sleeve, passes through a longitudinal hole purposely formed in the tail 4c and establish an electric contact with the negative pole of the series of batteries B.

Details of the electrical paths may be better observed in the enlarged view of FIG. 5.

FIGS. 6, 7 and 8 are schematic views in transparency of an earpiece of the present invention according to an alternative embodiment employing a single button battery B and a switch 11 of the so-called slider type instead of a push button switch of the prior embodiment and further implementing a different way of establishing the electrical connection between the powering and control elements contained at the free or distal end of the earpiece and a LED incorporated at the front end of the earpiece.

According to this alternative embodiment, the earpiece 1 of thermoplastic material may be formed in a mold in a substantially “monolithic” form, such to incorporate in the molded resin the front LED (which of course will only be partially encapsulated in the molded resin), a pair of conducting wires 17 and 18 for the powering of the LED 16 and two semi contacts 17a and 18a, to which the ends of the two wires 17 and 18 are connected. The semi contacts 17a and 18a are partially embedded in the resin at the bottom of the cavity of a hollow portion of enlarged cross section 1a of the molded earpiece.

A plug-in part 4 that is eventually inserted in side the cavity of the hollow portion la of the molded resin earpiece is a pre-constituted assembly or module, the portion of which that is received into the end cavity of the molded earpiece has on its lead surface two semi contacts 17b and 18b that establish electric contacts with the respective partially embedded terminations 17a and 18a of the pair of conducting wires incorporated in the molded resin. A secure electrical contact between the two pairs of semi contacts 17a-17b and 18a-18b, may be ensured by making the pair of semi contacts 17a and 18a of termination of the respective wires 17 and 18 incorporated in the molded resin of a ferromagnetic metallic material and the pair of semi contacts 17b and 18b with permanent magnets of an electrical conducting material. The magnetic attraction force beside ensuring a stable electrical contact also retains the pre-assembled module 4 once it is pushed fully inside the end cavity of the molded earpiece.

The pre-constituted end module 4 adapted to be at least partly received inside the end cavity of the molded earpiece houses a button battery B, the negative pole (−) of which is connected to the semi-contact 18b. The positive pole (+) is connected to the common lead of a slider switch 11, while the “output” lead 12 of the switch 11 is electrically connected to the semi-contact 17b on the lead surface of the plug-in module 4 pushed inside in the cavity, as shown in FIG. 9.

A shell 1b of the same plastic material with which is formed the molded front and proximal part of the earpiece 11 encapsulates the switch 11, the relative connecting leads or pins 10 and 12 and the plastic housing of the battery B and of the semi contacts 17b and 18b, letting protrude through a narrow slot 14 present on the terminal surface of the shell 1b, the control stem 13 of the slider switch 11.

Alternatively, a secure electrical contact between the semi contacts pairs 17a-17b and 18a-18b, may be ensured by making the pair of semi contacts 17b and 18b in the form of mobile metallic buttons with biasing springs, installed in respective cavities of the plastic housing of the battery. In this case, the retention of the module 4 plugged inside the end cavity of the molded front and proximal parts of the earpiece, may be ensured by common snap-action moldings or tonguings that are forcibly engaged exploiting the elastic memory of the cooperating geometric details formed in the molded material of which is made at least one of the two joinable parts, according to common practices of pre-arrangement of lockable features in separable parts of an assembled piece.

FIGS. 10 and 11 are photographic rendering of spectacles of the present invention employing earpieces according to the embodiment of FIG. 1-5.

As will be obvious to an informed reader, the battery or series of batteries used as sources of electrical energy for powering the light source, typically a LED, may be primary batteries, replaceable upon exhaustion, or alternatively they may be rechargeable batteries.

In the latter case, it may be contemplated the presence in the earpiece of a common jack for connection to an external battery charger or an embedded coil (secondary of an air transformer) and relative battery charging circuit powerable in a “contactless” fashion by an external device having a coil (primary of an air transformer) driven at high frequency mutually coupled to the embedded coil, according to common practices of contactless recharging of an embedded rechargeable battery of the earpiece.

1. Spectacles with light sources, connected in a powering circuit comprising a battery and an on/off switch, for illuminating an object observed through the lens of the spectacles, having earpieces hingedly connected to a front frame, characterized in that
each earpiece has at its free distal end a pre-constituted detachable module of a certain cross sectional size containing said battery, said switch and electrical connecting means and having a distal end surface, through an opening of which a control stem of the switch projects;
a pair of electrical supply wires of at least one light source present at the front end of the earpiece run inside a front and proximal part of the earpiece having a cross section that gradually increases as far as matching the cross section of said detachable distal end module.

2. The spectacles according to claim 1, wherein said earpieces have a box-like structure comprising two channel cross section semi-earpieces joined together defining at least a conduit inside which runs said pair of electrical supply wires of a LED held at the front end of the earpiece.

3. The spectacles according to claim 2, wherein said two channel cross section semi-earpieces joined together to constitute said front and proximal part of the earpiece have a slender cross section than the cross section of said detachable distal end module of the earpiece.

4. The spectacles according to claim 3, wherein said module is a metallic cartridge composed by a first half cartridge having a tail insertable inside a distal cavity of said box-like structure part of the earpiece formed by two semi-earpieces joined together and by a second half cartridge screwed to said first half cartridge and having an opening through its end surface through which a control stem of the switch projects; said pre-constituted detachable cartridge containing said switch, powering battery and electrical connection means to said pair of electric supply wires of said LED.

5. The spectacles according to claim 1, wherein
said earpieces are made in a monolithic form defining in a distal part of enlarged cross section a cavity adapted to receive a pre-constituted plug-in module containing said battery, switch and electrical connecting means, partly enveloped by an end shell, through an opening of which the control stem of the switch projects;
said electrical connection means comprising a pair of semi contacts adapted to contact respective semi contacts of termination of said pair of supply wires, of the light source partly embedded in the material of the formed monolithic earpiece at the bottom of said cavity.

6. The spectacles according to claim 5, wherein the electrical contact between said semi contact pairs is ensured by biasing springs acting on semi contacts present on the lead surface of said plugged-in module introduced a blocked inside said cavity.

7. The spectacles according to claim 5, wherein the electrical contact between said semi contact pairs is ensured by making said pair of terminations semi contacts with a ferromagnetic metallic material and said pair of semi contacts present on the lead surface of said plugged-in module with two permanent magnets of an elastically conducting material.

8. An earpiece for spectacles integrating a light source at its front end having at its free distal end a pre-constituted detachable module having a certain cross sectional size containing at least a powering battery, a switch and electrical connecting means to said light source and a distal end surface, through an opening of which a control stem of said switch projects; a pair of electrical supply wires of said light source present at the front end of the earpiece run inside a front and proximal part of the earpiece having a cross section that gradually increases as far as matching the cross section of said detachable distal end module.

9. The earpiece according to claim 8, characterized in that said front and proximal part has a box-like structure composed of two channel cross section elements joined together for defining at least a conduit inside which runs said pair of electrical supply wires of a LED held at the front end of the earpiece.

10. The earpiece according to claim 9, wherein said two channel cross section elements joined together to constitute said front and proximal part of the earpiece have a slender cross section than the cross section of said detachable distal end module of the earpiece.

11. The earpiece according to claim 10, wherein said module is a metallic cartridge composed by a first half cartridge having a tail insertable inside a distal cavity of said box-like structure part of the earpiece formed by two elements joined together and by a second half cartridge screwed to said first half cartridge and having an opening through its end surface through which a control stem of the switch projects;
said pre-constituted detachable cartridge containing said switch, powering battery and electrical connection means to said pair of electric supply wires of said LED.

12. The earpiece according to claim 8, characterized in that
it is made in a monolithic form defining in a distal part of enlarged cross section a cavity adapted to receive a pre-constituted plug-in module containing said battery, switch and electrical connecting means, partly enveloped by an end shell, through an opening of which the control stem of the switch projects;
said electrical connection means comprising a pair of semi contacts adapted to contact respective semi contacts of termination of said pair of supply wires, of the light source partly embedded in the material of the formed monolithic earpiece at the bottom of said cavity.

13. The earpiece according to claim 12, wherein electrical contact between said semi contact pairs is ensured by biasing springs acting on movably held semi contacts present on the lead surface of said plugged-in module introduced and blocked inside said cavity.

14. The earpiece according to claim 12, wherein the electrical contact between said semi contact pairs is ensured by making said pair of terminations semi contacts of a ferromagnetic metallic material and said pair of semi contacts present on the lead surface of said plugged-in module with two permanent magnets of an electrically conducting material.
